(19) United States
(12) Patent Application Publication
(10) Pub. No.: US 2016/0292873 A1
(43) Pub. Date: Oct. 6, 2016

(54) IMAGE CAPTURING APPARATUS AND METHOD FOR OBTAINING DEPTH INFORMATION OF FIELD THEREOF

(71) Applicant: HTC Corporation, Taoyuan City (TW)

(72) Inventors: Chun-Ta Lin, Taoyuan County (TW); Fu-Cheng Fan, Taoyuan County (TW)

(21) Appl. No.: 15/176,118

(22) Filed: Jun. 7, 2016

Related U.S. Application Data
(62) Division of application No. 14/180,372, filed on Feb. 14, 2014.
Application No. 14/180,372 is a continuation-in-part of application No. 13/224,364, filed on Sep. 2, 2011.
Application No. 13/224,364 is a continuation-in-part of application No. 13/937,223, filed on Jul. 9, 2013, now Pat. No. 9,160,917.

(51) Int. Cl. G06T 7/00; H04N 13/00; G06K 9/52; G06K 9/62; G06T 7/60; H04N 13/02; G06T 3/40

(52) U.S. Cl. CPC G06T 7/0075; H04N 13/0239; H04N 13/0022; G06T 3/40; G06K 9/6215; G06T 7/60; G06K 9/52; H04N 2013/0081; G06T 2200/04; G06K 2009/4666

(57) ABSTRACT

An image capturing apparatus and a method for obtaining a depth information of field thereof are provided. The image capturing apparatus includes a first image capturer, a second image capturer and a controller. The first image capturer performs an image capturing operation according to a plurality of focal lengths to respectively obtain a plurality of zoom images. The second image capturer performs an image capturing operation according to one focal length to obtain a fixed-focus image. The controller is coupled to the first and second image capturers, and the controller generates a plurality of depth information of field respectively corresponding to the focal lengths of the zoom images according to an image difference of the fixed-focus image and the zoom image.

### CROSS-REFERENCE TO RELATED APPLICATION

This application is a divisional application of U.S. application Ser. No. 14/180,372, filed on Feb. 14, 2014, now pending. The prior application Ser. No. 14/180,372 is a continuation-in-part application of and claims the priority benefit of U.S. application Ser. No. 13/224,364, filed on Sep. 2, 2011, now pending. The prior application Ser. No. 14/180,372 is also a continuation-in-part application of and claims the priority benefit of U.S. application Ser. No. 13/937,223, filed on Jul. 9, 2013, now U.S. Pat. No. 9,160,917. The entirety of each of the above-mentioned patent applications is hereby incorporated by reference herein and made a part of this specification.

### BACKGROUND OF THE INVENTION

1. Field of the Invention

The invention relates to an image capturing apparatus, and more particularly to an image capturing apparatus of a handheld electronic apparatus.

2. Description of Related Art

With advancement of electronic technologies, handheld electronic apparatuses have become an important tool in daily lives. A handheld electronic apparatus is usually disposed with an image capturing apparatus which is now a standard equipment for the handheld electronic apparatus.

Take a cell phone as an example, during an auto-focusing operation in conventional art, the image capturing apparatus (e.g., a camera) can scan an image by using an image sensor (e.g., a CMOS sensor) with movements of an actuator equipped therein, and record a contrast value of the image. The camera performs a focusing operation and performs an image capturing operation by selecting a proper moving distance for the actuator according to the contrast value of the image. Furthermore, in conventional art, the image capturing apparatus on the cell phone is restricted by a depth of field provided by a lens, such that a depth information of field of an image outside the depth of field can not be correctly obtained, thereby affecting a quality of the image being captured.

### SUMMARY OF THE INVENTION

The invention is directed to a plurality of image capturing apparatuses and method for obtaining depth information of field thereof, which is capable effectively calculate the depth information of field of a target image.

An image capturing apparatus of the invention includes a first image capturer, a second image capturer and a controller. The first image capturer performs an image capturing operation according to a plurality of focal lengths to respectively obtain a plurality of zoom images. The second image capturer performs an image capturing operation according to one fixed focal length to obtain a fixed-focus image. The controller is coupled to the first and second image capturers, and the controller generates a plurality of depth information of field respectively corresponding to the focal lengths of the zoom images according to the fixed-focus image and the zoom image.

Another image capturing apparatus of the invention includes a first image capturer, a second image capturer and a controller. The first image capturer performs an image capturing operation according to a plurality of focal lengths to respectively obtain a plurality of first zoom images. The second image capturer performs an image capturing operation according to the focal lengths to respectively obtain a plurality of second zoom images. The controller is coupled to the first image capturer and the second image capturer, and configured to generate a plurality of depth information of field respectively corresponding to the zoom images according to the first zoom images and the second zoom images.

The invention provides a method for obtaining depth information of field, which includes: performing an image capturing operation according to a plurality of focal lengths by a first image capturer to respectively obtain a plurality of zoom images; performing an image capturing operation according to one fixed focal length by a second image capturer to obtain a fixed-focus image; and generating a plurality of depth information of field respectively corresponding to the focal lengths of the zoom images according to an image difference of the zoom images and the fixed-focus image.

The invention provides another method for obtaining depth information of field, which includes: performing an image capturing operation according to a plurality of focal lengths by a first image capturer and a second image capturer to respectively obtain a plurality of first zoom images and a plurality of second zoom images; and generating a plurality of depth information of field respectively corresponding to the focal lengths of the zoom images according to the first and the second zoom images.

based on above, the image capturing apparatus of the invention is capable of capturing different zoom images through the first image capturer according different focal lengths, capturing the fixed-focus image through the second image capturer according to one fixed focal length, and calculating the depth information of field according to the zoom images and the fixed-focus image. In addition, the image capturing apparatus of the invention is also capable of obtaining the first and the second zoom images respectively according to different focal lengths, and calculating the depth information of field according to the first and the second zoom images. In other words, the invention is capable of effectively obtaining more accurate depth information of field through the zoom images created by at least one image capturer with auto focusing capability, so as to be used as a basis for calculating the depth information of field.

To make the above features and advantages of the disclosure more comprehensible, several embodiments accompanied with drawings are described in detail as follows.

### BRIEF DESCRIPTION OF THE DRAWINGS

FIG. 1 is a schematic view illustrating a handheld electronic apparatus 100 according to an embodiment of the invention.

FIG. 2 is a schematic view illustrating an image capturing apparatus 200 according to an embodiment of the invention.

FIG. 3A is a schematic view illustrating an implementation of the detection focusing distance according to an embodiment of the invention.

FIG. 3B is a schematic view illustrating an implementation of a conversion between the detection focusing distance and the main focusing distance.

FIG. 4 is a schematic view illustrating an image capturing apparatus 400 according to another embodiment of the invention.

FIG. 5A and FIG. 5B are schematic views illustrating a coverage status of view ranges of the image capturing apparatus according to an embodiment of the invention.

FIG. 6 is a flowchart illustrating a focusing method of the image capturing apparatus according to an embodiment of the invention.

FIG. 7 is a schematic view illustrating an image capturing apparatus 700 according to an embodiment of the invention.

FIG. 8A is a schematic view illustrating an image to be captured.

FIG. 8B is a schematic view illustrating a plurality of zoom images.

FIG. 9 is a schematic view of the zoom images according to an embodiment of the invention.

FIG. 10 is a schematic view illustrating an implementation for calculating the depth information of field the according to an embodiment of the invention.

FIG. 11 illustrates an implementation of the controller according to an embodiment of the invention.

FIG. 12 and FIG. 13 respectively illustrate a flowchart for obtaining the depth information of field according to two embodiments of the invention.

### DESCRIPTION OF THE EMBODIMENTS

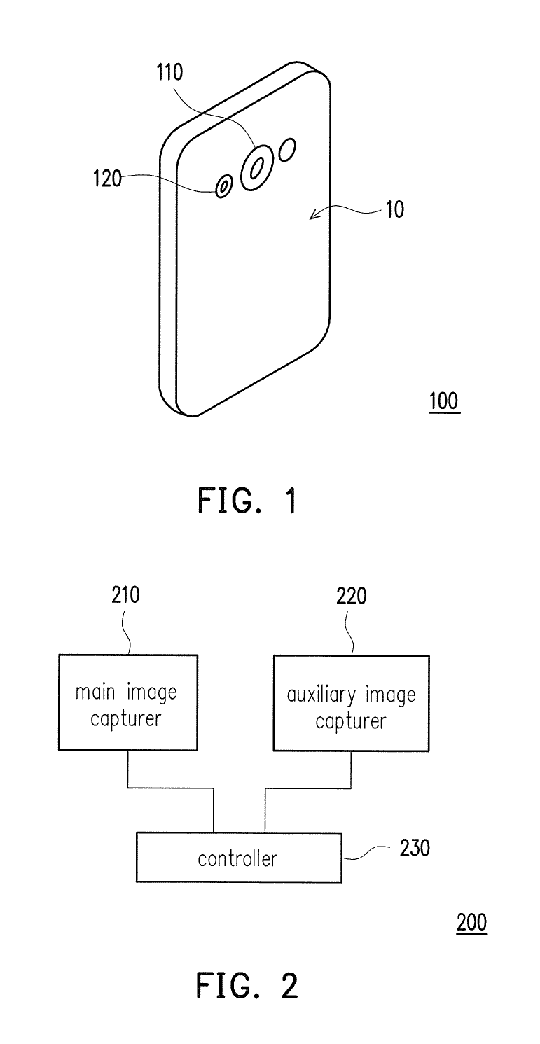

Referring to FIG. 1, FIG. 1 is a schematic view illustrating a handheld electronic apparatus 100 according to an embodiment of the invention. In the handheld electronic apparatus 100, the image capturing apparatus includes a main image capturer 110 and an auxiliary image capturer 120. The main image capturer 110 and the auxiliary image capturer 120 are disposed on the same plane of a substrate 10 of the handheld electronic apparatus 100. In addition, the main image capturer 110 and the auxiliary image capturer 120 are disposed adjacent to each other. In the present embodiment, the main image capturer 110 focuses on a target object according to a detection focusing distance and performs an image capturing operation. The detection focusing distance is generated by the auxiliary image capturer 120. More specifically, when the handheld electronic apparatus 100 performs a shooting (image capturing) operation on the target object, first, the auxiliary image capturer 120 performs a plurality of focusing operations on the target object according to a plurality of focusing distances. A plurality of image contrast values are generated by performing rapid image capturing operation on the target object under different focusing distances. The image contrast values are respectively corresponding to the focusing distances used in the focusing operations performed by the auxiliary image capturer 120. By analyzing the image contrast values, the image capturing apparatus of the handheld electronic apparatus 100 can select a highest value among the image contrast values, and select the focusing distance corresponding to the highest one among the image contrast value to be the detection focusing distance.

Accordingly, the main image capturer 110 can directly move a lens according to the detection focusing distance, and perform the image capturing operation on the target object. In other words, the main image capturer 110 can perform the focusing operations without repeatedly moving the lens for finding an optimal focusing distance, such that a time taken by the main image capturer 110 for performing the focusing operation can be saved.

It should be noted that, the main image capturer 110 as disposed in the present embodiment is a high-resolution image capturer, whereas the auxiliary image capturer 120 is a low-resolution image capturer. In other word, a speed for obtaining the image contrast values corresponding the focusing distances by using the auxiliary image capturer 120, is a lot faster than a speed for obtaining the same by using the main image capturer 110. In the present embodiment, a speed for performing the focusing operations by the auxiliary image capturer 120 is at least 8 times a speed for performing the focusing operation by the main image capturer 110.

Referring to FIG. 2, FIG. 2 is a schematic view illustrating an image capturing apparatus 200 according to an embodiment of the invention. The image capturing apparatus 200 includes a main image capturer 210, an auxiliary image capturer 220 and a controller 230. The auxiliary image capturer 210 and the main image capturer 220 are coupled to the controller 230. When the image capturing apparatus 200 performs an image capturing operation, first, the auxiliary image capturer 220, under control of the controller 230, sequentially performs a plurality of focusing operations on a target object respectively according to a plurality of focusing distances. The focusing distances can be sequentially ascending, or sequentially descending, based on an order of the focusing operations. Further, the auxiliary image capturer 220 performs the image capturing operation on the target object under different focusing distances, and a captured image is then transferred to the controller 230 for analyzing. The controller 230 analyzes the image contrast values from received images, and finds a highest value among the image contrast values. The controller 230 selects the focusing distance corresponding to the highest value among the image contrast values, such that a detection focusing distance is obtained.

On a basis that the disposing positions of the main image capturer 210 and the auxiliary image capturer 220 are sure to be different from one another, the controller 230 performs a conversion according to the detection focusing distance, and generates a main focusing distance accordingly. The main focusing distance can be directly provided for the main image capturer 210 to perform the focusing operations. Therein, the controller 230 can perform the conversion of the detection focusing distance and the main focusing distance by utilizing a relation between a distance from the main image capturer 210 to the target object and a distance from the auxiliary image capturer 220 to the target object. Above-mentioned relation between the distances can be obtained by a designer by performing practical measurements to the image capturing apparatus 200. Data content of the relation can be implemented into a lookup table and recorded in a memory.

In addition, the main image capturer 210 can include a main image sensing chip, and the auxiliary image capturer 220 can include an auxiliary image sensing chip. A size of the main image sensing chip 210 is greater than a size of the auxiliary image sensing chip 220.

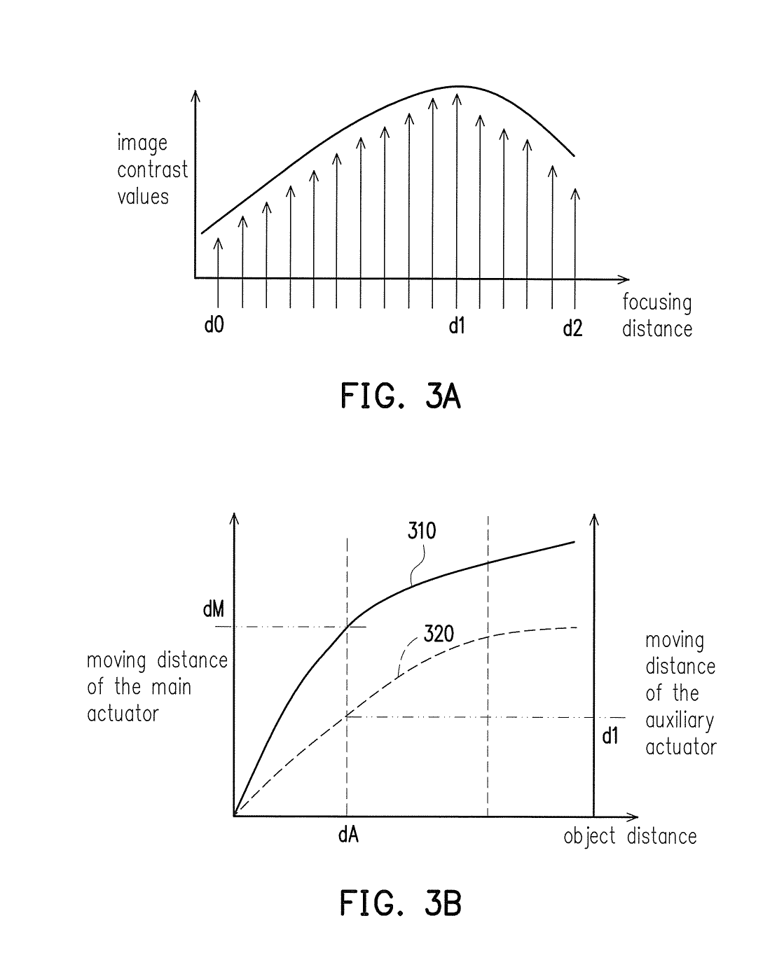

Referring to FIG. 2, FIG. 3A and FIG. 3B, FIG. 3A is a schematic view illustrating an implementation of the detection focusing distance according to an embodiment of the invention, and FIG. 3B is a schematic view illustrating an implementation of a conversion between the detection focusing distance and the main focusing distance. In FIG. 3A, the auxiliary image capturer 220 performs an image capturing operation on the target object according to a plurality of ascending focusing distances d0˜d11˜d2, so as to obtain a plurality of image contrast values. Further, in correspondence to the focusing distances d0˜d1, the image contrast values is ascending as the focusing distance increases; and in correspondence to the focusing distances d1˜d2, the image contrast values is descending as the focusing distance increases. In other words, since the image contrast value corresponding to the focusing distance d1 is of the highest value, thus the controller 230 can select the focusing distance d1 to be the detection focusing distance.

In view of FIG. 3A, it can be known that the auxiliary image capturer 230 does not need to perform the focusing operations and the image capturing operation for all of the focusing distances d0˜d2. While the focusing operations and the image capturing operation are performed by the auxiliary image capturer 220, the controller 230 can determine a variation trend with respect to rising and falling of the image contrast values. When the variation trend of the image contrast values is changed from rising to falling, the controller 230 can then select the focusing distance corresponding to the highest one among the image contrast values.

In addition, in FIG. 3B, curves 310 and 320 represent a relation diagram between moving distances of an auxiliary actuator and a main actuator under different object distances. Therein, the auxiliary image capturer 220 performs the focusing operations through a movement of the auxiliary actuator, and the main image capturer 210 performs the focusing operation through a movement of the main actuator. In view of FIG. 3B, it can be known that in case the object distance is equal to a distance dA, when the auxiliary actuator moves for a focusing distance d1 equal to the detection focusing distance, the main focusing distance of the main actuator corresponding being moved is a focusing distance dM.

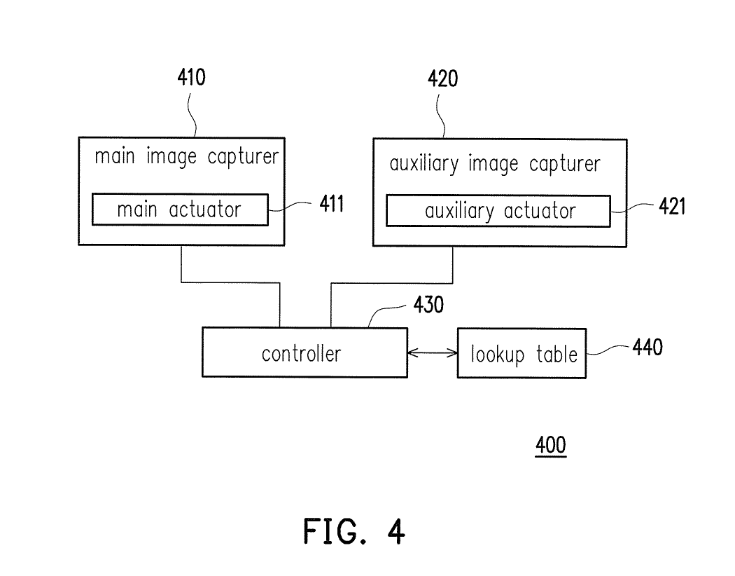

Referring to FIG. 4, FIG. 4 is a schematic view illustrating an image capturing apparatus 400 according to another embodiment of the invention. The image capturing apparatus 400 includes a main image capturer 410, an auxiliary image capturer 430, a controller 440 and a lookup table 440. The main image capturer 410 includes a main actuator 411, and the auxiliary image capturer 420 includes an auxiliary actuator 421. The main actuator 411 and the auxiliary actuator 412 are coupled to the controller 430 and moved according to the commands transferred by the controller 430, so as to make the main image capturer 410 and the auxiliary image capturer 420 to perform the focusing operations. The lookup table 440 is coupled to the controller 430, and the lookup table 440 can record information of a relation between the curves 310 and 320, as depicted in FIG. 3B.

In the present embodiment, the main actuator 411 and the auxiliary actuator 412 can be a voice coil motor (VCM), a stepping motor or motors in various types. The voice coil motor is an apparatus capable of converting an electrical energy into a mechanical energy while realizing a linear movement and a movement with limited swing angle. The voice coil motor generates a regular movement by utilizing a mutual effect of magnetic poles between a magnetic field from a permanent magnet steel and a magnetic field generated by conducting coil conductors. Since the voice coil motor is a non-commutated power apparatus, a positioning accuracy thereof is fully depended on a control system of the voice coil motor. The stepping motor is a motor having stators and rotors which are projected as wheels jointing each other, and gradually rotating in a specific angle by switching a current flowed into a stator coil. The stepping motor can switch triggering operations of the current through a pulse signal without performing a detecting operations on positions and speeds of the rotors. Thus, the stepping motor can rotate accurately and proportionally according to the pulse signal being received, so as to accurately control a position and a speed thereof, thereby providing a more preferable stability.

For an implementation of the lookup table 440, the lookup table 440 can be constructed by using a non-volatile memory module, so that the relation of the curves 310 and 320 depicted in FIG. 3B can be digitalized so digitalized values can then be written into the lookup table 440.

Besides being disposed outside the controller 430 as to be coupled to the controller 430, the lookup table 440 can also be embedded in the controller 430. In summary, a location of the lookup table 440 is not particularly limited.

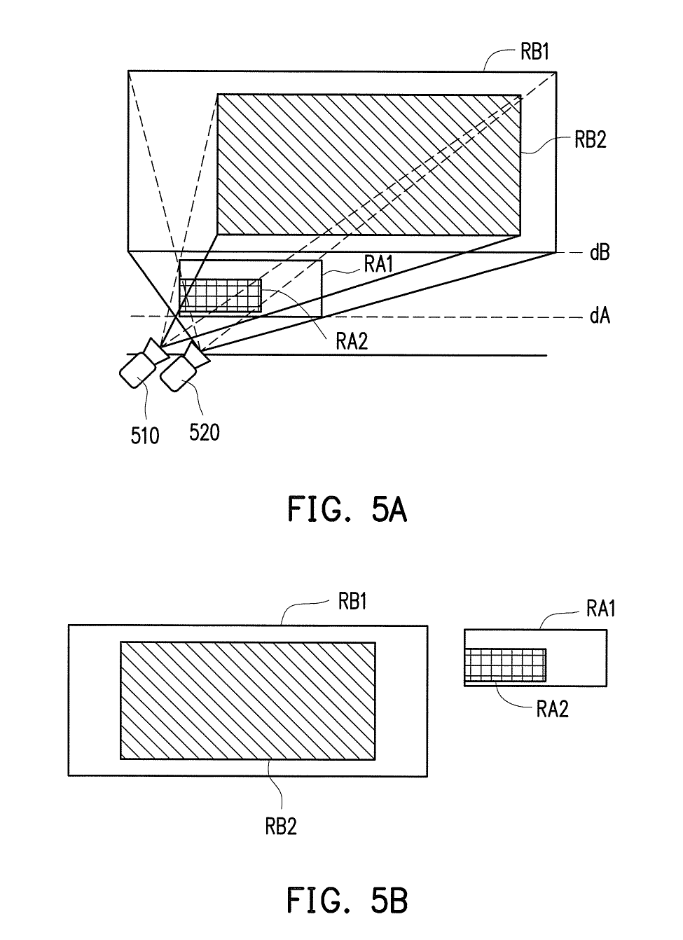

Referring to FIG. 5A and FIG. 5B, FIG. 5A and FIG. 5B are schematic views illustrating a coverage status of view ranges of the image capturing apparatus according to an embodiment of the invention. In FIG. 5A, view ranges of a main image capturer 510 and an auxiliary image capturer 520 at an object distance dA are RA1 and RA2, respectively; and view ranges of the main image capturer 510 and the auxiliary image capturer 520 at an object distance dB are RB1 and RB2, respectively. It can be clearly found in FIG. 5B that, the view ranges RA1 and RB1 of the main image capturer 510 respectively cover the view ranges RA2 and RB2 of the auxiliary image capturer 520. Of course, in other embodiments of the invention, the view range of the auxiliary image capturer 520 can also be slightly smaller than the view range of the main image capturer 510.

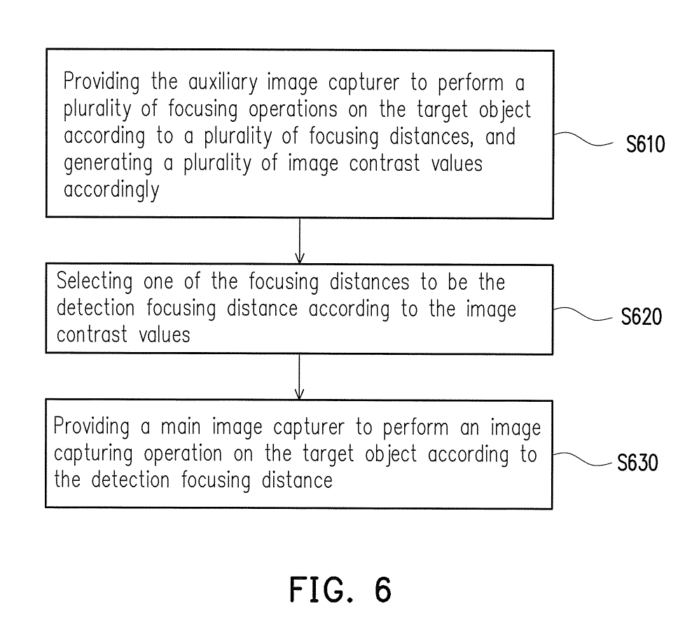

Referring to FIG. 6, FIG. 6 is a flowchart illustrating a focusing method of the image capturing apparatus according to an embodiment of the invention. In step S610, the auxiliary image capturer is provided to perform a plurality of focusing operations on the target object according to a plurality of focusing distances, and to generate a plurality of image contrast values. Next, in step S620, one of the focusing distances is selected to be the detection focusing distance according to the image contrast values. Next, in step S630, a main image capturer is provided to perform an image capturing operation on the target object according to the detection focusing distance.

In addition, for assigning a portion on the target object, a user can select the target object to the focused by using a touching method on a display frame displayed on the screen of the handheld electronic apparatus. Or, the handheld electronic apparatus can recognize a face portion of a person within the view range by using a facial recognition technology, so as to perform the focusing operation on the face portion of the person which is served as the target object. Of course, the handheld electronic apparatus can also select the target object suitable for the embodiments of the invention by using other methods.

Relevant implementation detail for the steps above has been described in the previous embodiments and implementations, thus it is omitted hereinafter.

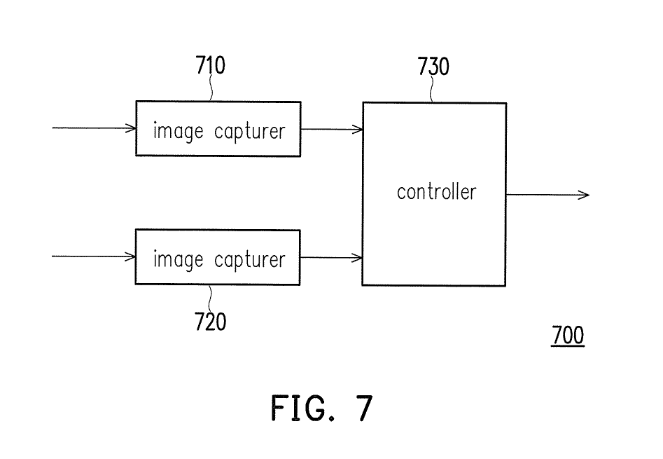

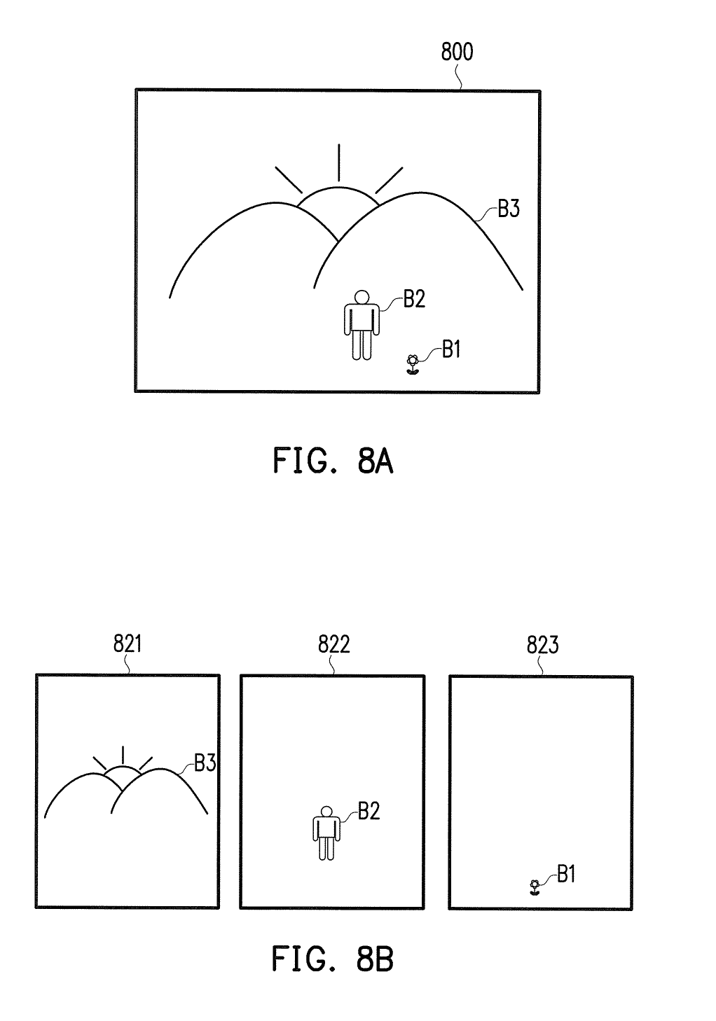

Referring to FIG. 7, FIG. 7 is a schematic view illustrating an image capturing apparatus 700 according to an embodiment of the invention. The image capturing apparatus 700 includes image capturers 710 and 720, and a controller 730. The image capturers 710 and 720 are coupled to the controller 730. Further, the image capturer 710 may perform an image capturing operation according to a plurality of focal lengths to respectively obtain a plurality of zoom images. The second image capturer 720 may perform an image capturing operation according to one focal length to obtain a fixed-focus image. It should be noted that, the focal lengths used by the image capturer 710 may be generated according to a plurality of objects with different depth of field in the image, or may be a set of predetermined values. Referring to FIG. 7, FIG. 8A to 8B, FIG. 8A is a schematic view illustrating an image to be captured, and FIG. 8B is a schematic view illustrating a plurality of zoom images. Therein, in an image 800 that is to be captured, objects B1 to B3 with different depth of field are included. The object B1 with a little flower pattern has the depth of field being the smallest, the object B2 with a human pattern has the depth of field being slightly greater than that of the object B1, and the object B3 served as a background including a mountain and a sun has the depth of field being relatively greater.

When the image capturer 710 performs the image capturing operation to the image 800, the focusing operation may performed to the objects B1 to B3 to generate a plurality of focal lengths, and a plurality of zoom images 821 to 823 may be captured according to those different focal lengths. The zoom image 821 is image data obtained by the image capturer 710 according the focal length being relatively farther, wherein the focal length is obtained by focusing on the object B3 served as the background including the mountain and the sun, and, the object B3 with the mountain and the sun is an object that is relatively clearer. The zoom image 822 is image data obtained by the image capturer 710 according the focal length being relatively closer, wherein the focal length is obtained by focusing on the object B2 with the human pattern, and, the object B2 with the human pattern is an object that is relatively clearer. The zoom image 823 is image data obtained by the image capturer 710 according the focal length being the closest, wherein the focal length is obtained by focusing on the object B1 with the little flower pattern, and, the object B1 with the human pattern is an object that is relatively clearer.

On the other hand, the image capturer 720 performs the image capturing operation to the image 800 according to one fixed focal length to obtain one fixed-focus image, and an image resolution of the image capturer 720 may be lower than an image resolution of the image capturer 710. And, the controller 730 receives the zoom images 821 to 823 obtained by the image capturer 710 and the fixed-focus image obtained by the image capturer 720, and then calculates a plurality of depth information of field of the image 800 according to the zoom images 821 to 823 and the fixed-focus image.

As implementation detail for obtaining the depth information of field, the controller 830 may perform an image processing to the zoom images 821 to 823, and respectively capture clear object images from the clear objects B3 to B therein. In an implementation of the present embodiment, the controller 830 may perform an image merging operation to the obtained clear object images, so as to generate a complete clear object image. Then, the controller 830 performs a calculation by using the complete clear object image together with the zoom images, so as to obtain the depth information of field of the image 800.

In another implementation of the present embodiment, the controller 830 may respectively perform the calculation for the depth information of field by using the zoom images 821 to 823 together with the fixed-focus image, so as to obtain the depth information of field of the image 800.

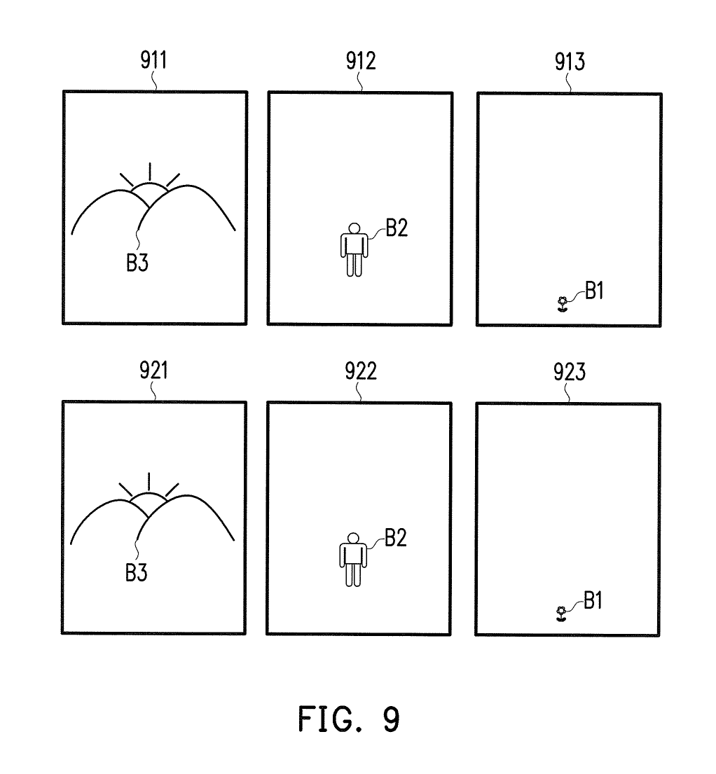

In other embodiments of the invention, the image capturers 710 and 720 may also be image capturers having similar resolutions. And, the image capturers 710 and 720 respectively perform the image capturing operations to the image 800 according to a plurality of focal lengths, so as obtain a plurality of zoom images, respectively. Referring to FIG. 7 and FIG. 9 together, FIG. 9 is a schematic view of the zoom images according to an embodiment of the invention.

In FIG. 9, clear object images 911 to 913 are obtained by the image capturer 710 after performing the image capturing operation to the image 800 respectively according to the focal lengths, whereas clear object images 921 to 923 are obtained by the image capturer 720 after performing the image capturing operation to the image 800 respectively according to the focal lengths. The clear object images 911 and 921 are image data obtained by focusing on the object B3; the clear object images 912 and 922 are image data obtained by focusing on the object B2; and the clear object images 913 and 923 are image data obtained by focusing on the object B1. It should be noted that, the focal lengths used by the image capturer 710 and the image capturer 720 during the image capturing operations to the same object are substantially the same.

Herein, the controller 730 may calculate a depth information of field for the clear object images 911 and 921, calculate another depth information of field for the clear object images 912 and 922, and calculate yet another depth information of field for the clear object images 913 and 923. Or, as another implementation, the controller 730 may also merge the clear object images 911 to 913 into one clear object image, and merge the clear object images 921 to 923 into another cleat object image. The controller 730 may then calculate the depth information of field according to said two clear image object images.

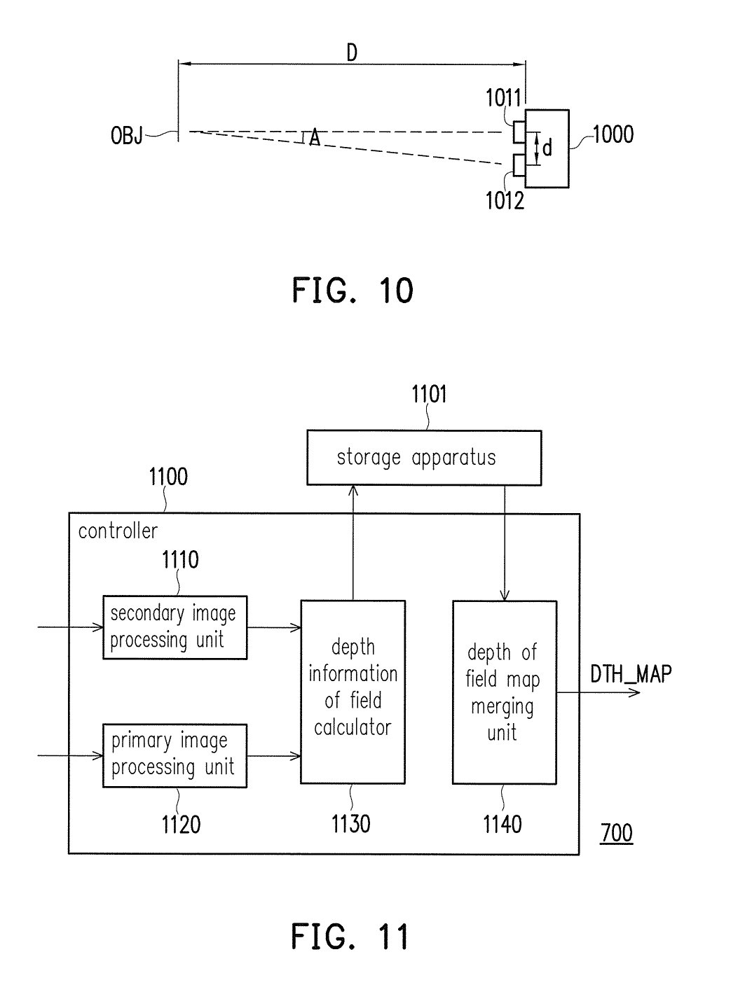

Referring to FIG. 10, FIG. 10 is a schematic view illustrating an implementation for calculating the depth information of field the according to an embodiment of the invention. In FIG. 10, image capturers 1011 and 1012 are disposed on an image capturing apparatus 1000. The image capturing apparatus 1000 may be disposed on a handheld electronic apparatus (e.g., a cell phone). Herein, a distance between the image capturers 1011 and 1012 is d, and the focusing operation is performed to an object OBJ to perform the image capturing operation. And, a distance between the image capturing apparatus 1000 and the object OBJ is D, and a disparity angle generated between the image capturers 1011 and 1012 and the object OBJ is A. Accordingly, a depth information of field DEPTH of the object OBJ is as shown by an equation below:

$$DEPTH = \frac{d}{2 \times D \times tan \frac{A}{2}} \times 100 \%$$

It should be noted that, when the image capturing apparatus 1000 is adapted in the handheld electronic apparatus, the distance d between the image capturers 1011 and 1012 may be not greater than 7 cm.

Additionally, it should also be noted that, the image capturers 1011 and 1012 may be disposed in parallel on the image capturing apparatus 1000, and may perform the image capturing operation to the object OBJ respectively according to different focal lengths. Accordingly, images respectively captured by the image capturers 1011 and 1012 may be used as a stereopsis or video for the object OBJ, and said images may be merged by an image synchronizer in the image capturing apparatus 1000 to generate a merged image. The image capturing apparatus 1000 may also include an image adjuster to filter out an image attenuation in said merged image, so as to generate an adjusted image.

Referring to FIG. 11, FIG. 11 illustrates an implementation of the controller according to an embodiment of the invention. In the present embodiment, a controller 1100 includes a secondary image processing unit 1110 and a primary image processing unit 1120, a depth information of field calculator 1130 and a depth of filed map merging unit 1140. The controller 1100 may be coupled to a storage apparatus 1101. The secondary image processing unit 1110 and the primary image processing unit 1120 are coupled to the depth information of field calculator 1130. The image capturer coupled to secondary image processing unit 1110 captures image data by utilizing a zooming method, and the secondary image processing unit 1110 processes a plurality of received zoom images, so as to respectively capture a plurality of clear object images in the zoom images. The primary image processing unit 1120 may be coupled to the image capturer that captures image according to one fixed focal length, and may also be coupled to the image capturer that captures the image data by utilizing the zooming method. When the primary image processing unit 1120 receives a fixed-focus image, the primary image processing unit 1120 may perform an image processing to the fixed-focus image, so as to generate a processed fixed-focus image. On the other hand, when the primary image processing unit 1120 receives the zoom images, the primary image processing unit 112 processes the received zoom images, so as to capture additional clear object images, respectively.

The depth information of field calculator 1130 may receive the clear object images generated by the secondary image processing unit 1110 and the processed fixed-focus image generated by the primary image processing unit 1120, so as to calculate the depth information of field. Or, the depth information of field calculator 1130 may also receive the clear object images generated by the secondary and the primary image processing units 1110 and 1120, so as to calculate the depth information of field. The depth information of field calculated by the depth information of field calculator 1130 may be transmitted to the storage apparatus 1101 for storage. The depth of field map merging unit 1140 is coupled to the storage apparatus 1101, and configured to read the depth information of field from the storage apparatus 1101 to be merged for generating a depth of filed map DTH_MAP.

In another embodiment of the invention, the secondary image processing unit 1110 may perform an image capturing operation to a plurality of partial regions having an image clarity higher than a threshold in the zoom images, so as to obtain a plurality of partial region images. The primary image processing unit 1120 may process the fixed-focus image to generate the processed fixed-focus image. The depth information of field calculator 1130 may generate a plurality of depth information of field respectively corresponding to the partial region images according to the obtained partial region images and the fixed-focus image. Then, the depth of field map merging unit 1140 may generate the depth of field map DTH_MAP accordingly.

It should be noted that, the depth information of field calculator 1130 may generate a complete region image according to the partial region images, and generate the depth information of field according to an image difference of the complete region image and the processed fixed-focus image.

In yet another embodiment of the invention, in case the image capturers coupled to the secondary image processing unit 1110 and the primary image processing unit 1120 respectively perform the image capturing operation according to a plurality of focal lengths, and respectively obtains a plurality of first and second zoom images, the secondary image processing unit 1110 and the primary image processing unit 1110 are served as first and second image processing units, respectively. Therein, the first image processing unit captures a plurality of first partial region images having an image clarity higher than a threshold in the first zoom images, and the second image processing unit captures a plurality of second partial region images having an image clarity higher than a threshold in the second zoom images. The depth information of field calculator 1130 generates a first complete region image and a second complete region image according to the first and the second partial region images, and generates the depth information of field according to the first complete region image and the second complete region image.

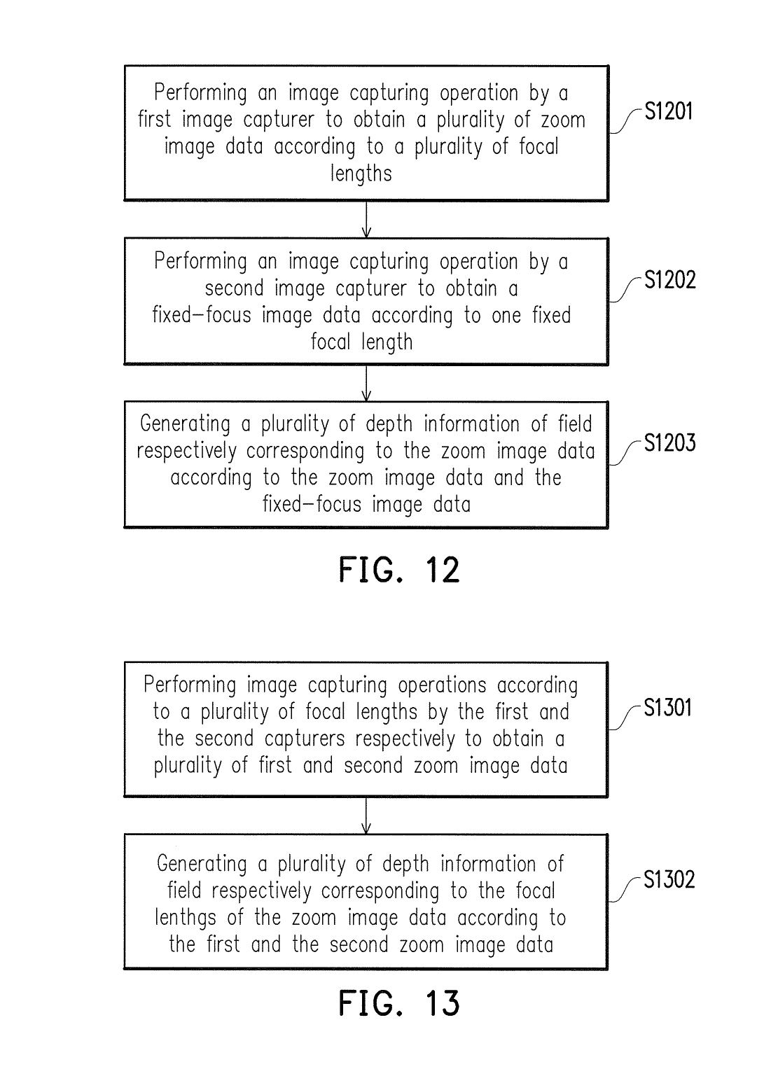

Referring to FIG. 12 and FIG. 13, FIG. 12 and FIG. 13 respectively illustrate a flowchart for obtaining the depth information of field according to two embodiments of the invention. In view of FIG. 12, in step S1201, an image capturing operation is performed by a first image capturer to obtain a plurality of zoom images according to a plurality of focal lengths, and in step S1202, an image capturing operation is performed by a second image capturer to obtain a fixed-focus images according to one focal length. Further, in step S1203, a plurality of depth information of field respectively corresponding to the zoom images are generated according to the zoom images and the fixed-focus image.

In above-said embodiment, an image resolution of the first image capturer is higher than an image resolution of the second image capturer, and a captured image resolution of the first image capturer is equal to a captured image resolution of the second image capturer.

In aforesaid steps, an order of step S1201 and step S1202 is not particularly limited as above, that is, the image capturing operations of the first and the second image capturers may be performed simultaneously or sequentially.

In view of FIG. 13, a plurality of first and second zoom images are obtained by the first and the second capturers respectively after performing image capturing operations according to a plurality of focal lengths in step S1301, and a plurality of depth information of field respectively corresponding to the zoom images are generated according to the first and the second zoom images in step S1302. Similarly, an order of the image capturing operations of the first and the second image capturers is not particularly limited as above, that is, the image capturing operations of the first and the second image capturers may be performed sequentially or simultaneously.

In addition, implementation detail of steps for obtaining the depth information of field in the FIG. 12 and FIG. 13 has been described specifically in the foregoing embodiments and implementations, thus it is not repeated hereinafter.

In summary, the invention is capable of capturing the zoom images by utilizing at least one image capturer, and calculating the depth information of field of the image according to the fixed-focus image obtained according to the fixed focal lengths or the additional zoom images. As a result, the depth information of field of the image may be effectively and accurately calculated and provided for subsequent image processing operations.

What is claimed is:

1. An image capturing apparatus, comprising:
a first image capturer performing an image capturing operation according to a plurality of focal lengths to respectively obtain a plurality of first zoom images;
a second image capturer performing an image capturing operation according to the focal lengths to respectively obtain a plurality of second zoom images; and
a controller coupled to the first image capturer and the second image capturer, and the controller generating a plurality of depth information of field respectively corresponding to the zoom images according to the first zoom images and the second zoom images.

2. The image capturing apparatus of claim 1, wherein the image capturing operations of the first image capturer and the second image capturer are performed sequentially or simultaneously.

3. The image capturing apparatus of claim 1, wherein an image resolution of the first image capturer is higher than an image resolution of the second image capturer, and a captured image resolution of the first image capturer is equal to a captured image resolution of the second image capturer.

4. The image capturing apparatus of claim 1, wherein the controller comprises:
a first secondary image processing unit coupled to the first image capturer, and configured to capture a plurality of first partial region images having an image clarity higher than a threshold in the first zoom images;
a second secondary image processing unit coupled to the second image capturer, and configured to capture a plurality of second partial region images having an image clarity higher than the threshold in the second zoom image; and
a depth information of field calculator, generating the depth information of field respectively corresponding to the first and the second partial region images according to the first and the second partial region images.

5. The image capturing apparatus of claim 4, further comprising:
a storage apparatus coupled to the controller, configured to receive and store the depth information of field.

6. The image capturing apparatus of claim 5, wherein the controller further comprises:
a depth of field map merging unit, coupled to the storage apparatus,
configured to read the depth information of field in the storage apparatus for merging so as to generate a depth of field map.

7. The image capturing apparatus of claim 1, wherein the controller generates the information of field respectively according to an image difference of the first and the second partial region images.

8. The image capturing apparatus of claim 1, wherein the controller generates a first complete region image and a second complete region image respectively according to the first and the second partial region images, and generates the depth information according to an image difference of the first complete region image and the second complete region image.

9. The image capturing apparatus of claim 1, wherein a distance between the first image capturer and the second image capturer is not greater than 7 cm.

10. A method for obtaining depth information of field, comprising:
performing an image capturing operation according to a plurality of focal lengths by a first image capturer and a second image capturer to respectively obtain a plurality of first zoom images and a plurality of second zoom images; and
generating a plurality of depth information of field respectively corresponding to the zoom images according to the first and the second zoom images.

11. The method for obtaining depth information of field of claim 10, wherein the step of generating the depth information of field respectively corresponding to the zoom images according to the first and the second zoom images comprises:
generating the depth information of field respectively according the first clear object image and the second clear object image.

12. The method for obtaining depth information of field of claim 10, wherein the step of generating the depth information of field respectively corresponding to the focal lengths of the zoom images according to the first and the second zoom images comprises:
capturing a plurality of first partial region images having an image clarity higher than a threshold in the first zoom images;
capturing a plurality of second partial region images having an image clarity higher than a threshold in the second zoom images;
generating a first complete region image and a second complete region image respectively according to the first and the second partial region images; and
generating the depth information of field by performing a calculation according to the first complete region image and the second complete region image.

13. The method for obtaining depth information of field of claim 10, wherein a distance between the first image capturer and the second image capturer is not greater than 7 cm.
